(19) United States
(12) Patent Application Publication
(10) Pub. No.: US 2004/0109050 A1
(43) Pub. Date: Jun. 10, 2004

(54) Ink-jet image forming apparatus

(75) Inventor: Yong-Sok Yang, Yongin-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-city (KR)

(21) Appl. No.: 10/642,689

(22) Filed: Aug. 19, 2003

(30) Foreign Application Priority Data
Aug. 17, 2002 (KR) 2002-48728

(51) Int. Cl. B41J 2/185

(52) U.S. Cl. 347/90

(57) ABSTRACT

An ink-jet printer includes an ink cartridge mounted in a carriage that is disposed at a guide shaft and reciprocates, and having a print head formed at a lower portion thereof to eject ink on an ink ejecting area, a feeding roller to convey printing paper under the print head, and a waste ink-collecting unit to collect waste ink that is ejected from the print head onto an area other than the printing paper. The waste ink-collecting unit includes a waste ink-collecting tank disposed under the print head, to collect the waste ink falling down from the print head, and a collecting roller rotatably disposed at an entrance of the collecting tank, to guide the waste ink falling down from the print head to the collecting tank.

### CROSS-REFERENCE TO RELATED APPLICATIONS

This application is based on Korean Patent Application No. 2002-48728, filed Aug. 17, 2002, in the Korean Intellectual Property Office, the disclosure of which is incorporated herein by reference.

### BACKGROUND OF THE INVENTION

1. Field of the Invention

The present invention relates to an image forming apparatus, for example, an ink-jet printer.

2. Description of the Related Art

Generally, an image forming apparatus such as an ink-jet printer has a carriage 13 containing an ink-cartridge 15 therein, as shown in FIG. 1. The carriage 13 reciprocates along a guide shaft 14 disposed in a main frame 10. That is, the carriage 13 is reciprocally moved by a moving unit that has a timing belt (not shown) therein. The ink cartridge 15 has a print head 15a at a lower side thereof. The print head 15a is disposed to have a predetermined head gap with respect to a printing paper P conveyed between a feeding roller 16 and a compressing roller 17. While being controlled by a control unit during driving, the print head 15a ejects ink onto the printing paper P to print an image. That is, the print head 15a ejects the ink onto the printing paper P through an ink nozzle (not shown) from a predetermined distance. As the ink is ejected to the printing paper P, an image appears. At this point, the ink ejection through the ink nozzle is properly controlled according to image information that is input from the control unit of the printer. Also, the paper P passing through the print head 15a is guided by a guide frame 18 disposed at a lower side of the carriage 13 and is discharged.

Meanwhile, the print head 15a ejects the ink and develops the image while moving across a conveying direction of the printing paper P along with the carriage 13. At this point, the print head 15a reciprocates within a printing area of the printing paper P. That is, margins are created on the right and the left sides and the upper and the lower ends of the printing paper P, and the printing paper P cannot be printed without the margins.

The current trend of ink-jet printers either for photographic or general use is so-called “borderless printing,” in which the image is printed on a whole area of the printing paper without leaving a margin. The borderless printing is especially necessary when printing photographs, which do not have margins and require a high quality output.

However, the conventional technology has difficulty in achieving the borderless printing. That is, the borderless printing first requires the print head 15a of the ink cartridge 15 to eject the ink, as shown in FIG. 2. The print head 15a has to eject the ink on an ink ejecting area A that includes a border edge of the printing paper P and an outer area beyond the border to thus print the paper without leaving the margin. The ink drop I that falls onto the area beyond the border of the paper is accumulated on the paper guide frame 18. The ink on the paper guide frame 18 contaminates an upper side or a backside of the printing paper P.

Accordingly, as the ink drop I continuously accumulates on the paper guide frame 18, there occur problems of deteriorated printing quality and improper movement along a conveying path of the printing paper P.

### SUMMARY OF THE INVENTION

Accordingly, it is an aspect of the present invention to solve the above and/or other problems in the related art.

Accordingly, it is another aspect of the present invention to provide an ink-jet printer having an improved structure capable of performing borderless printing, i.e., printing an image on the entire area of the printing paper.

Additional aspects and/or advantages of the invention will be set forth in part in the description which follows and, in part, will be obvious from the description, or may be learned by practice of the invention.

The foregoing and/or other aspects of the present invention are achieved by providing an ink-jet printer including a guide shaft; a carriage supported by the guide shaft and reciprocating thereon; an ink cartridge mounted in the carriage and having a print head to eject ink on an ink ejecting area of a printing paper; a feeding roller to convey the printing paper to the print head; and a waste ink-collecting unit to collect waste ink that is ejected from the print head onto an area other than the printing paper, the waste ink-collecting unit including a waste ink-collecting tank disposed adjacent to the print head, to collect the waste ink from the print head, and a collecting roller rotatably disposed at an entrance of the collecting tank, to guide the waste ink from the print head to the collecting tank.

The waste ink-collecting unit may further include a paper guide frame to guide the printing paper conveyed by the feeding roller to have a predetermined head gap with respect to the print head, and having an opening corresponding to the ink ejecting area and the collecting roller.

The waste ink-collecting unit may further include a cleaning unit to clean the waste ink on the collecting roller.

The cleaning unit may include a cleaning blade spaced apart from an outer circumference of the collecting roller, to scrape the accumulation of waste ink from the outer circumference of the collecting roller, and a cleaning member disposed in contact with the collecting roller, to absorb remaining waste ink that is not removed by the cleaning blade.

The cleaning blade may be integrally formed with the collecting tank and protrude from an inner circumference of the collecting tank. The collecting roller may be connected to the feeding roller via a gear train and rotate in association with the feeding roller. An inside of the collecting tank may be provided with an ink absorbent body of porous material, to absorb the collected waste ink in the collecting tank. The cleaning blade and the cleaning member may have respective lengths greater than or equal to that of the collecting roller. The collecting roller may be shorter than the collecting tank in length.

### BRIEF DESCRIPTION OF THE DRAWINGS

These and/or other aspects and/or advantages of the invention will become apparent and more readily appreciated from the following description of the embodiments, taken in conjunction with the accompanying drawings of which:

FIG. 1 is a schematic side sectional view showing a general ink-jet printer;

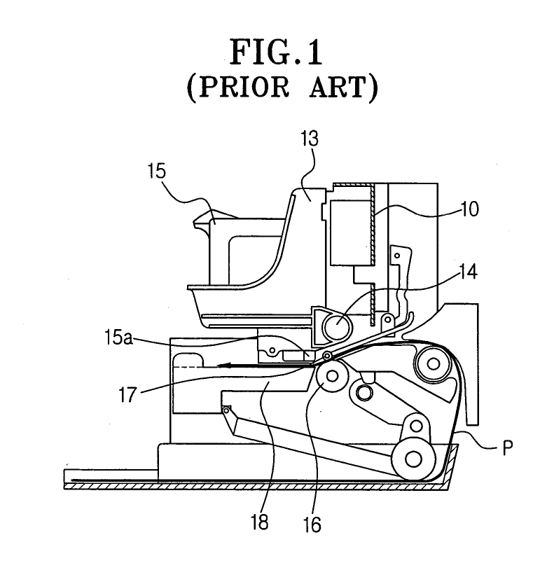

FIG. 2 is a view showing a portion of FIG. 1;

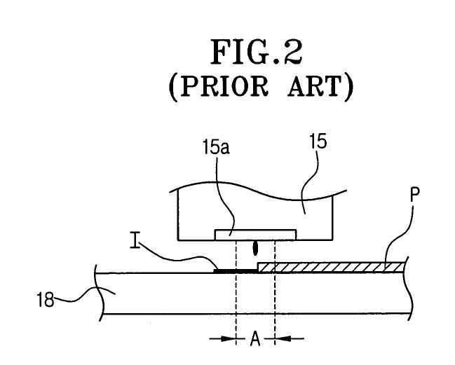

FIG. 3 is a schematic side sectional view showing an ink-jet printer according to an embodiment of the present invention; and

FIG. 4 is a schematic plan view showing the ink-jet printer of FIG. 3.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

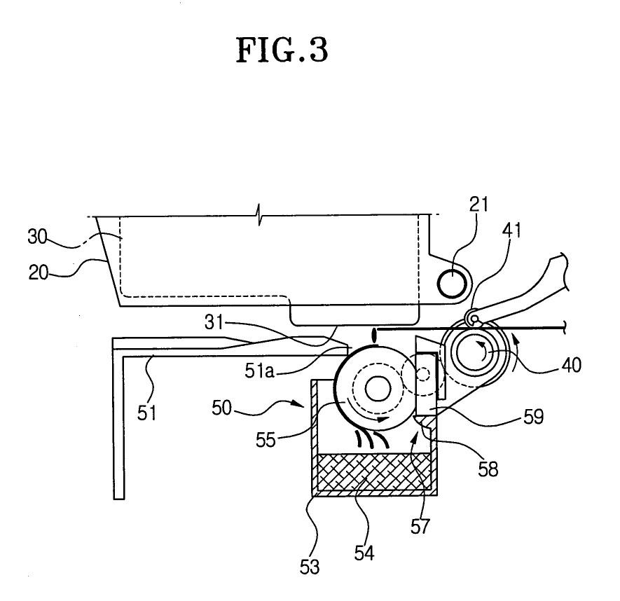

Referring to FIG. 3, an ink-jet printer according to an embodiment of the present invention includes an ink cartridge 30 having a print head 31 disposed at a lower side thereof to eject ink, a feeding roller 40 to convey printing paper under the print head 31, and a waste ink-collecting unit 50 to collect waste ink that is ejected on an area other than the printing paper.

The ink cartridge 30 is removably mounted in a carriage 20. The carriage 20 is reciprocally and slidably supported on a guide shaft 21 disposed at a main frame of the ink-jet printer. The guide shaft 21 is disposed in a direction perpendicular to a conveying direction of the printing paper, to guide the reciprocal movement of the carriage 20.

The feeding roller 40 conveys the printing paper supplied through a predetermined paper path under the print head 31. The feeding roller 40 rotates in contact with a pressing roller 41. The printing paper passes between the feeding roller 40 and the pressing roller 41.

The waste ink-collecting unit 50 includes a paper guide frame 51 to guide the printing paper conveyed under the print head 31, a waste ink-collecting tank 53 disposed under the paper guide frame 51, a collecting roller 55 disposed at an entrance of the waste ink-collecting tank 53, and a cleaning unit 57 to clean the collecting roller 55.

The paper guide frame 51 is disposed under the ink cartridge 30. The printing paper conveyed along the paper guide frame 51 is guided to maintain a predetermined head gap with respect to the print head 31. Also, the paper guide frame 51 has an opening 51a cut away in correspondence with an ink ejecting area of the print head 31. Accordingly, the waste ink that is not transferred to the printing paper among the ink ejected from the print head 31 falls down through the opening 51a.

The waste ink-collecting tank 53 is disposed under the opening 51a, to contain the waste ink that falls down through the opening 51a. Inside of the waste ink-collecting unit 53 is provided an absorbent body 54 made of a porous material to absorb and collect the dropped waste ink.

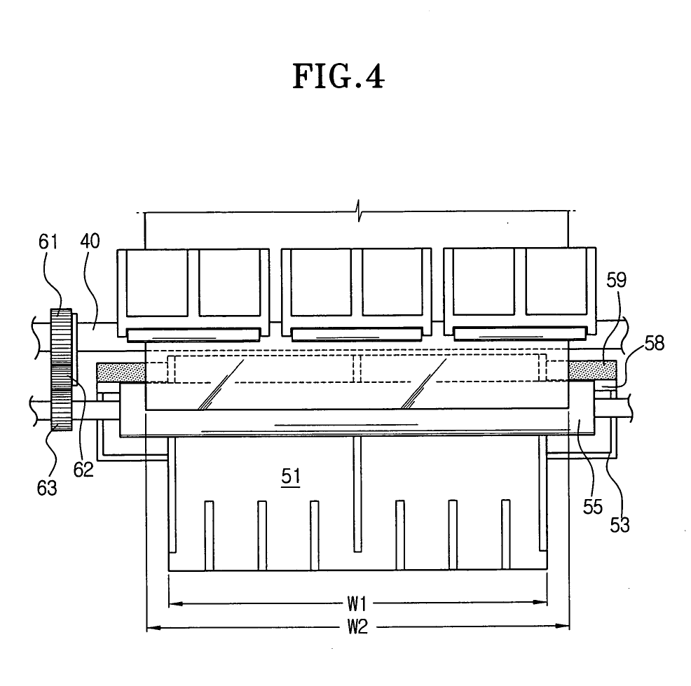

The collecting roller 55 is disposed at the entrance of the waste ink-collecting tank 53, i.e., it is disposed to correspond to the opening 51a. That is, the collecting roller 55 is disposed directly under the opening 51a so that it does not interfere with the printing paper passing between the print head 31 and the paper guide frame 51 and receives the waste ink falling down through the opening 51a. Also, as shown in FIG. 4, the collecting roller 55 has a length longer than a width w1 of the paper guide frame 51 and a width w2 of the printing paper. Also, the length of the collecting roller 55 is smaller than that of the waste ink-collecting tank 53 so that the waste ink on an outer circumference of the waste ink-collecting roller 55 accurately falls into the waste ink-collecting tank 53. Also, in association with the feeding roller 40, the collecting roller 55 rotates in the same direction as the feeding roller 40. The collecting roller 55 is connected to the feeding roller 40 via gear trains 61, 62, and 63 to achieve the rotation in the same direction.

The cleaning unit 57 includes a cleaning blade 58 to initially remove the waste ink from an outer circumference of the waste ink collecting roller 55 without being in contact with the outer circumference, and a cleaning member 59 to remove the remaining waste ink from the collecting roller 55.

The cleaning blade 58 is integrally formed with the collecting tank 53 and protrudes from an inner wall of the collecting tank 53 toward the collecting roller 55 by a predetermined height. The cleaning blade 58 scrapes the waste ink of a predetermined height from the collecting roller 55.

The cleaning member 59 is disposed at an upper portion of the cleaning blade 58 to contact the collecting roller 55. The cleaning member 59 overlaps the collecting roller 55 and absorbs the waste ink on the outer circumference of the collecting roller 55. For this, the cleaning member 59 is made of material such as a sponge.

The cleaning blade 58 and the cleaning member 59 have respective lengths greater than or equal to that of the collecting roller 55.

The process of borderless printing using the ink-jet printer according to the embodiment of the present invention will now be described.

First, the printing paper passes between the feeding roller 40 and the pressing roller 41 with its front end advancing under the print head 31. That is, when the front end of the printing paper is placed between the print head 31 and the opening 51a of the paper guide frame 51, the ink cartridge 30 is moved in a width direction of the printing paper. Then, the print head 31 ejects the ink to print the front end of the printing paper. At this point, the ejected ink falls into the opening 51a as well as the front end of the printing paper. The waste ink falls on the outer circumference of the collecting roller 55.

The waste ink on the outer circumference the collecting roller 55 flows along the outer circumference of the collecting roller 55 and drops into the collecting tank 53. The waste ink still remaining on the collecting roller 55 is first removed by the cleaning blade 58 with the collecting roller 55 being rotated, and is then removed by the cleaning member 59. At this point, the cleaning blade 58 scrapes and removes the accumulation of waste ink of a predetermined thickness without contacting the collecting roller 55. Meanwhile, while in contact with the collecting roller 55, the cleaning member 59 absorbs and removes the thin layer of waste ink remaining on the collecting roller 55. Accordingly, with the collecting roller 55 being rotated, almost all of the waste ink of the collecting roller 55 is removed by passing through the cleaning blade 58 and the cleaning member 59.

Also, the waste ink dropped into the opening 51 a can be collected when the printing is performed with respect to the entire area of the printing paper as well as the front end of the printing paper. Also, the waste ink can be efficiently collected regardless of the type of ink, for example, pigment or dye.

The ink-jet printer according to the present invention as described above has a structure capable of collecting the ink that is ejected out of the range of the printing paper when performing borderless printing, thereby preventing the printing paper from being contaminated with the waste ink. Accordingly, the reliability of a product can be increased.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An ink-jet printer comprising:
a guide shaft;
a carriage supported by the guide shaft and reciprocating thereon;
an ink cartridge mounted in the carriage and having a print head to eject ink on an ink ejecting area of a printing paper;
a feeding roller to convey the printing paper to the print head; and
a waste ink-collecting unit to collect waste ink that is ejected from the print head onto an area other than the printing paper,
the waste ink-collecting unit comprising:
a waste ink-collecting tank disposed adjacent to the print head, to collect the waste ink from the print head, and
a collecting roller rotatably disposed at an entrance of the collecting tank, to guide the waste ink from the print head to the collecting tank.

2. The ink-jet printer of claim 1, wherein the waste ink-collecting unit further comprises a paper guide frame to guide the printing paper conveyed by the feeding roller to have a predetermined head gap with respect to the print head, and having an opening corresponding to the ink ejecting area and the collecting roller.

3. The ink-jet printer of claim 2, wherein the waste ink-collecting unit further comprises a cleaning unit to clean the waste ink on the collecting roller.

4. The ink-jet printer of claim 3, wherein the cleaning unit comprises:
a cleaning blade spaced apart from an outer circumference of the collecting roller, to scrape the waste ink from the outer circumference of the collecting roller; and
a cleaning member disposed in contact with the collecting roller, to absorb the waste ink that is not removed by the cleaning blade.

5. The ink-jet printer of claim 4, wherein the cleaning blade is integrally formed with the collecting tank and protrudes from an inner circumference of the collecting tank.

6. The ink-jet printer of claim 3, further comprising a gear train to connect the collecting roller to the feeding roller, wherein the collecting roller rotates in association with the feeding roller.

7. The ink-jet printer of claim 2, wherein an inside of the collecting tank includes an ink absorbent body of a porous material, to absorb the collected waste ink in the collecting tank.

8. The ink-jet printer of claim 4, wherein the cleaning blade and the cleaning member have lengths greater than or equal to a length of the collecting roller.

9. The ink-jet printer of claim 3, wherein the collecting roller is shorter than the collecting tank in length.

10. An apparatus comprising:
a print head to eject ink towards a paper; and
a frame to guide the paper, the frame forming a hole to pass the ejected ink not received by the paper.

11. The apparatus of claim 10, wherein the paper maintains a constant head gap with the frame.

12. The apparatus of claim 10, further comprising a waste collector to collect the ink which has passed through the hole.

13. The apparatus of claim 12, wherein the waste collector comprises a first roller to receive the ink which has passed through the hole.

14. The apparatus of claim 13, wherein the waste collector further comprises a tank to collect the ink which is received by the first roller.

15. The apparatus of claim 14, wherein the waste collector further comprises a second roller to receive the ink from the first roller which is not collected by the tank.

16. The apparatus of claim 15, wherein the second roller is a sponge.

17. The apparatus of claim 13, wherein the first roller has a length longer than a width of the frame and a width of the paper.

18. The apparatus of claim 13, wherein the first roller has a length shorter than a length of the tank and a width of the paper.

19. The apparatus of claim 13, further comprising a second roller to feed the paper to the print head, the first and third rollers rotating in a same direction.

20. The apparatus of claim 15, wherein the waste collector further comprises a blade protruding from the tank to scrape the ink from the first roller.
